(19) United States
(12) Patent Application Publication
(10) Pub. No.: US 2016/0303728 A1
(43) Pub. Date: Oct. 20, 2016

(54) Hammer Buffer

(71) Applicant: Caterpillar Inc., Peoria, IL (US)

(72) Inventors: Pradeep Chapagain, Peoria Heights, IL (US); Sunil I. Mathew, Peoria, IL (US); Rakesh Jagdale, Waco, TX (US)

(73) Assignee: CATERPILLAR INC., Peoria, IL (US)

(21) Appl. No.: 14/689,954

(22) Filed: Apr. 17, 2015

(51) Int. Cl. B25D 17/24; E02F 3/96

(52) U.S. Cl. CPC B25D 17/24; E02F 3/966

(57) ABSTRACT

A buffer for an upper surface of a power cell of a hammer is provided. The buffer includes a substantially cylindrical body having an upper surface, a lower surface and a sidewall. A recess extends into the body from the lower surface of the body for engagement with the upper surface of the power cell. The recess has a first section having a first interior wall extending inward relative to the body at a first angle with respect to a line parallel to the lower surface and a second section having a second interior wall extending inward relative to the body at a second angle with respect to the line parallel to the lower surface.

### TECHNICAL FIELD

This disclosure relates generally to powered hammers and, more particularly, to a top buffer for a power cell of a powered hammer.

### BACKGROUND

Powered hammers may be used at work sites to break up hard objects such as rocks, concrete, asphalt, frozen ground, or other materials. The powered hammers may be mounted to machines, such as backhoes and excavators, or may be hand-held. Such hammers may include a pneumatically or hydraulically actuated power cell having an impact system operatively coupled to a tool. The impact system generates repeated, longitudinally directed forces against a proximal end of the tool disposed inside the hammer housing. The tool extends from the housing to engage the hard object. The forces against the proximal end of a tool are transmitted through the tool to break-up the hard object.

Powered hammers are typically provided with one or more buffers that are arranged to absorb at least some of the dynamic forces generated by operation of the hammer. The buffers may include one or more top buffers arranged on top of the power cell of the hammer that absorb vibration produced by the power cell as it drives the tool. Many of these buffers have configurations including features that are subject to folding under loads which can lead to cracking and premature failure of the buffer. Moreover, many buffers have configurations that do not adequately absorb the loads produced by operation of the hammer, which can make the hammer more difficult to operate and again can lead to premature failure of the buffer. Premature failure of one or more of the buffers associated with a hammer can result in increased down time for the hammer so that the buffers can be replaced. This increased downtime can decrease the efficiency of the hammer and lead to increased hammer operating costs

One example of a top buffer assembly for a hammer is disclosed in U.S. Pat. No. 6,095,257. The disclosed buffer assembly includes a top buffer, a top buffer plate and a sliding plate. These components are held together by a connection member that prevents the sliding plate and the top buffer plate from becoming misaligned with the respect to the center assembly. Dealing with the multiple parts of the buffer, including the need to keep the multiple parts in alignment can lead to additional time and effort necessary to service the hammer. This can result in increased downtime resulting in lower efficiency and increased operating costs.

### SUMMARY

In one aspect, the disclosure describes a buffer for an upper surface of a power cell of a hammer. The buffer including a substantially cylindrical body having an upper surface, a lower surface and a sidewall. A recess extends into the body from the lower surface of the body for engagement with the upper surface of the power cell. The recess has a first section having a first interior wall extending inward relative to the body at a first angle with respect to a line parallel to the lower surface and a second section having a second interior wall extending inward relative to the body at a second angle with respect to the line parallel to the lower surface. The first angle is greater than the second angle.

In another aspect, the disclosure describes a hammer including a housing, a power cell arranged in the housing and a buffer arranged on the power cell. The buffer including a substantially cylindrical body having an upper surface, a lower surface and a sidewall. A recess extends into the body from the lower surface of the body for engagement with the upper surface of the power cell. The recess has a first section having a first interior wall extending inward relative to the body at a first angle with respect to a line parallel to the lower surface and a second section having a second interior wall extending inward relative to the body at a second angle with respect to the line parallel to the lower surface. The first angle is greater than the second angle.

In yet another aspect, the disclosure describes a buffer for an upper surface of a power cell of a hammer. The buffer includes a substantially cylindrical single-piece body having an upper surface, a lower surface and a sidewall. A recess extends into the body from the lower surface of the body for engagement with the upper surface of the power cell. The recess having a first section having a first interior wall extending inward relative to the body at a first angle with respect to a line parallel to the lower surface and a second section having a second interior wall extending inward relative to the body at a second angle with respect to the line parallel to the lower surface. The first interior wall angles inward continuously until the first interior wall terminates at the second interior wall and the second interior wall angles inward continuously until the second interior wall terminates at an intermediate surface that extends parallel to the lower surface.

### BRIEF DESCRIPTION OF THE DRAWINGS

FIG. 1 is a side view of an exemplary machine supporting a hammer according to the present disclosure

FIG. 2 is a partially exploded perspective view of an exemplary hammer according to the present disclosure.

FIG. 3 is a bottom perspective view of an exemplary buffer such as for use with the hammer of FIG. 2.

FIG. 4 is a bottom view of the buffer of FIG. 3.

FIG. 5 is a side sectional view of the buffer of FIG. 3.

FIG. 6 is a partial side sectional view of the buffer of FIG. 3 arranged on an accumulator assembly of a hammer and in a deformed state.

### DETAILED DESCRIPTION

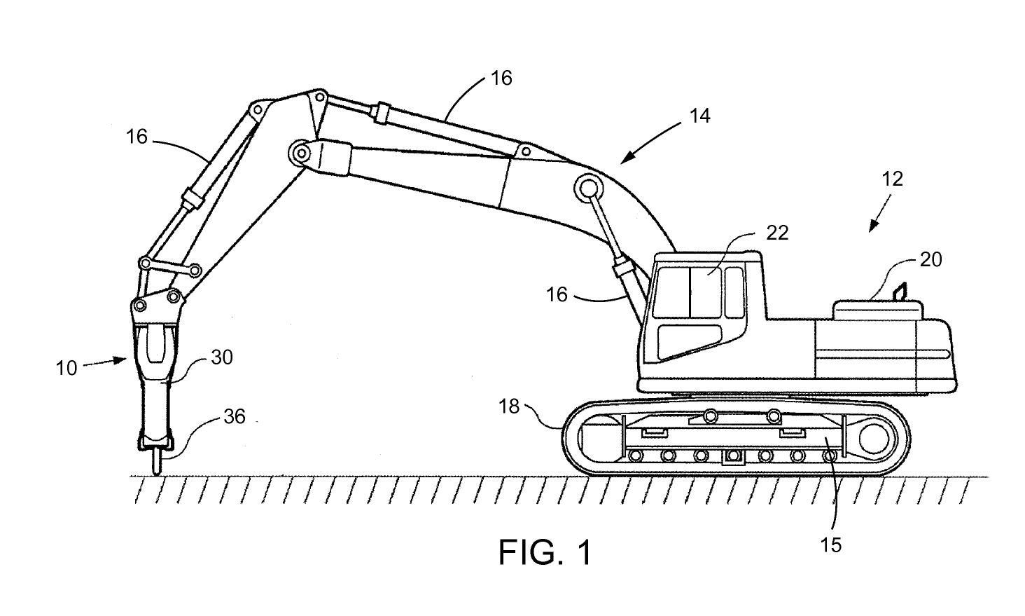

This disclosure generally relates to a powered hammer buffer which may absorb some of the forces produced by operation of the hammer. With particular reference to FIG. 1, an exemplary embodiment of a hammer 10 that is supported on a machine 12 according to the present disclosure is shown. The machine 12 may embody a fixed or mobile machine that performs some type of operation associated with an industry such as mining, construction, farming, transportation, or any other industry known in the art. For example, the machine 12 may be a lift truck, telehandler, skid steer loader, wheel loaders, track loader, excavator, backhoe or tractor. While the hammer 10 is shown in connection with a machine, the present disclosure is not limited to machine mounted hammers. Rather, the present disclosure is equally applicable to handheld hammers.

The hammer 10 may be supported on the machine 12 by a linkage 14. The linkage 14 may be articulated relative to a frame 15 of the machine, such as by actuators 16, in order to change an orientation and/or position of the hammer 10 with respect to a ground surface. The machine 12 may further include a drive system 18 for propelling the machine 12, a power source 20 that provides power to the actuators 16 associated with the linkage 14 supporting the hammer 10 and the drive system 18. The machine 12 may further include an operator station 22 that may include appropriate controls for manipulating the linkage 14 and controlling operation of the hammer 10 and the drive system 18. The power source 20 may embody an engine such as, for example, a diesel engine, a gasoline engine, a gaseous fuel-powered engine or any other type of combustion engine known in the art. Additionally, the power source 20 may alternatively embody a non-combustion source of power such as a fuel cell, a power storage device, or another source known in the art. The power source 20 may produce a mechanical or electrical power output that may then be converted to hydraulic pneumatic power for moving the linkage 14 supporting the hammer 10.

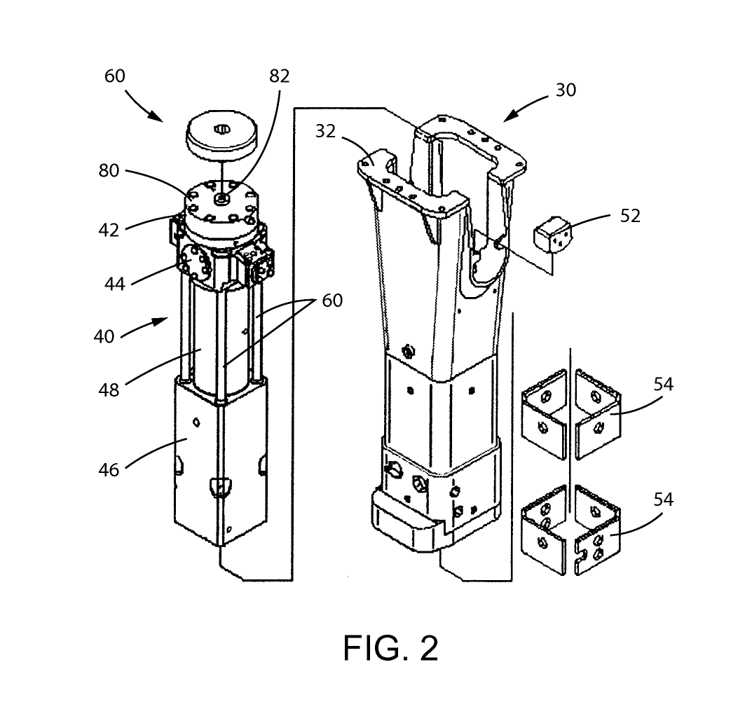

Referring to the exploded view of FIG. 2, the exemplary hammer 10 may include a housing 30 having an upper end 32 and a lower end 34. As used herein, the terms upper and lower refer to when the hammer 10 is an upright position such as shown in FIGS. 1 and 2. A work tool 36 (shown in FIG. 1) may be slidably supported in a lower portion of the housing 30 with a portion of the work tool 36 extending therefrom. Additionally, a piston (not shown) may be slidably supported in the housing 30 so as to be movable relative to the housing in a reciprocating manner. For example, during an impact or work stroke, the piston comes into contact with the work tool 36. When the piston contacts the work tool 36, the force is transmitted to the tool which, in turn, may be applied to a hard object such as rock, concrete or asphalt in order to break up the object. In a return or retract stroke, the piston moves away from the work tool 36. The work tool 36 may have any configuration, such as for example a chisel, that may be useful in a hammering application. The work tool 36 may also be configured to be removable so as to allow a variety of different tools with different configurations to be connected to the hammer 10.

The reciprocating movement of the piston, and in turn the work tool 36, may be driven by a power cell 40. As shown in FIG. 2, the power cell 40 may be supported in the housing 30 and may include an accumulator assembly 42, a valve assembly 44 and a front head 46. The accumulator assembly 42 may be arranged at the upper end of the power cell 40 just above the valve assembly 44. An impact system 48, which may include the piston, may be sandwiched between the front head 46 and the valve assembly 44 and accumulator assembly 42. The piston may extend into the front head 46. As shown in FIG. 2, tie rods 50 may be used to hold various components of the power cell 40 together. The power cell 40 may be powered by any suitable means, such as pneumatically-powered or hydraulically-powered. For example, a hydraulic or pneumatic circuit (not shown) may provide pressurized fluid (via, for example, the valve assembly) to drive the piston toward the tool 36. A plate may be connected to the proximal end of the housing such that the top buffer is held in engagement with the accumulator and captured between the accumulator and the plate. During the work stroke and to return the piston during the return stroke. Those skilled in the art will appreciate that the present disclosure is not limited to any particular pressurized fluid system and that any suitable arrangement capable of driving reciprocating movement of the piston may be used.

The hammer 10 may include a buffer system that may be configured to absorb some of the forces produced by the power cell 40 during operation of the hammer 10. The buffer system may include a pair of side buffers 52 (one of which can be seen in FIG. 2) that are supported on the housing 30 so as to engage side surfaces of the power cell 40. The two side buffers 52 may be positioned on opposing sides of the housing 30. Any number of side buffers 52 may be used and the side buffers may be positioned in any suitable manner with respect to the power cell 40. The housing 30 may also support a lower buffer (not shown in FIG. 2) that may be arranged near the lower end 34 of the housing 30 and is configured to engage with the lower end of the power cell 40. Wear plates 54 also may be provided in the housing 30 in order to guide and support the front head 46.

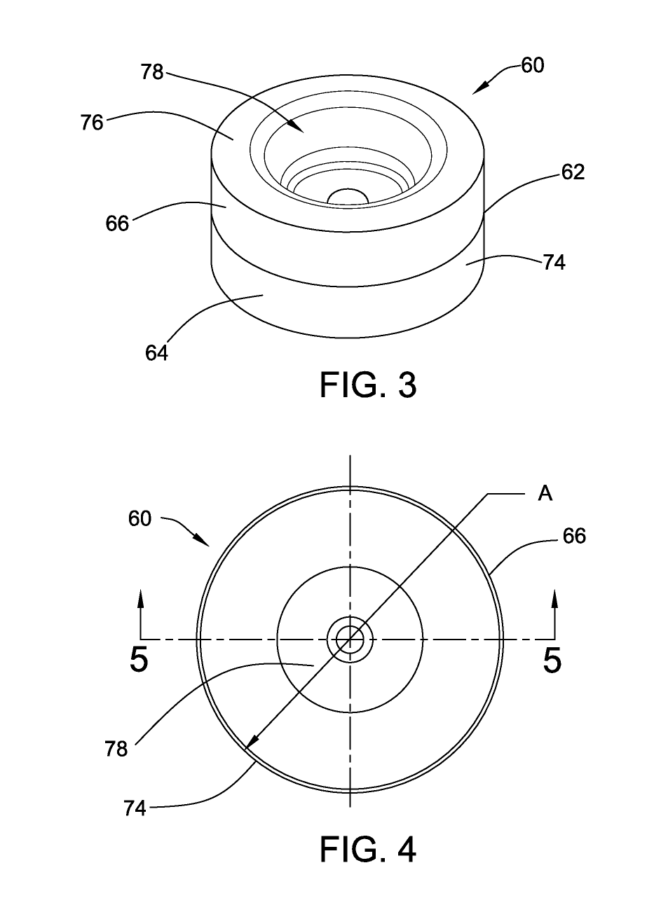

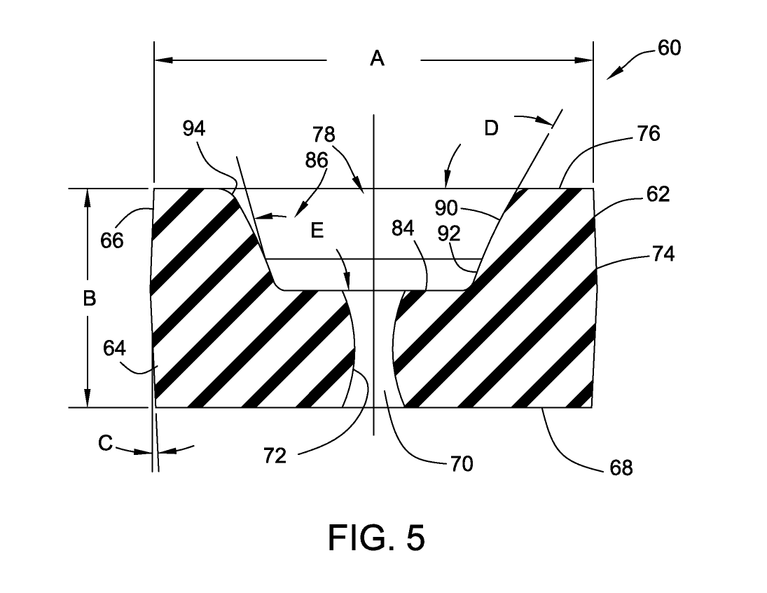

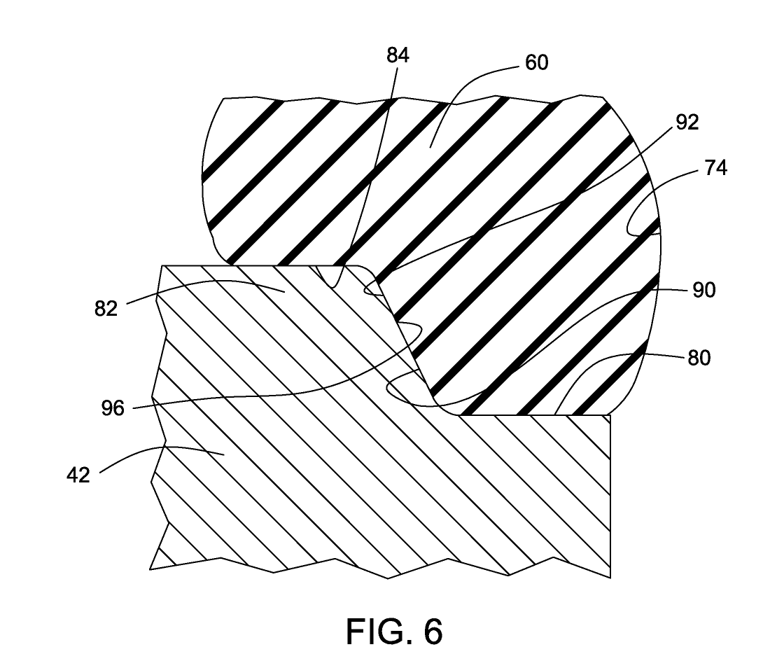

The buffer system may further include a top buffer 60 that may be arranged in engagement with an upper portion of the accumulator assembly 42 as shown in FIG. 2. A plate may be connected to the upper end of the housing 30 such that the top buffer 60 is held in engagement with the accumulator assembly 42 and captured between the accumulator assembly 42 and the plate. As shown in FIGS. 3 and 4, the top buffer 60 may have a generally cylindrical body 62 and include an upper portion 64 and a lower portion 66 (seen in FIG. 3). Moreover, the top buffer 60 may have a single piece construction. The top buffer 60 may be made of rubber or any other suitable resilient material. When installed in the housing 30 on the accumulator assembly 42, the lower portion 66 of the top buffer 60 engages the accumulator assembly 42 (see FIGS. 2 and 6). In the cross-section of FIG. 5, the top buffer 60 is shown inverted consistent with the bottom views of FIGS. 3 and 4 in order to better show the features on the lower portion 66 of the buffer. Thus, in FIG. 5, the lower portion 66 of the top buffer 60 is on the top and the upper portion is on the bottom.

While the top buffer 60 can be of any desired size, in particular to mate with different sized hammers, according to one embodiment, the diameter A to height B ratio of the top buffer 60 may be kept relatively constant across the different sizes. According to one embodiment, the diameter A to height B ratio of the top buffer 60 may be approximately 2.0 to approximately 2.4 no matter the overall size of the top buffer. Maintaining a substantially constant diameter A to height B ratio no matter the desired size of the top buffer 60 can help provide similar stiffness parameters for the top buffer across different sizes.

The upper portion 64 of the top buffer 60 may define a substantially flat upper surface 68 as shown in FIG. 5. Additionally, a central upper opening 70 may be formed in the upper portion 64 that extends downwardly from the upper surface 68. As shown in FIG. 5, the upper opening 70 may have a substantially hourglass cross-sectional shape with a sidewall 72 that curves inwardly as it extends away from both the upper and lower ends of the upper opening until the curve reaches its apex around the midpoint of the upper opening 70. As will be appreciated by those skilled in the art from the present disclosure, the upper portion 64 of the top buffer 60 may have a configuration different from that shown in FIG. 3.

The sidewall 74 of the body 62 of the top buffer 60 may be substantially solid without any openings formed therein as best shown in FIG. 3. The elimination of any openings in the sidewall 74 can improve performance of the top buffer 60 as horizontally or radially extending openings or holes in the sidewall 74 can be a source of folding and crack propagation when the buffer is under load. Moreover, the sidewall 74 may be configured so that it bulges slightly outward with the bulge reaching its maximum at approximately the midpoint of the height B of the sidewall 74. More particularly, the sidewall 74 may angle slightly in an outward direction as it extends away from both the upper and lower surfaces 68, 76 of the top buffer until the angular surfaces intersect at approximately the midpoint of the height B of the top buffer 60. Accordingly to one embodiment, the sidewall 74 may extend outward at an angle C of approximately 2° to approximately 5° with respect to a vertical line extending perpendicularly with respect to the upper and lower surfaces 68, 76 of the top buffer 60.

The lower portion 66 of the top buffer 60 may be configured with a lower recess 78 that is configured in a complementary manner to the upper surface 80 of the accumulator assembly 42 of the hammer 10. In particular, the recess 78 may be configured to receive a protruding portion 82 of the upper surface 80 of the accumulator assembly 42. As shown in FIG. 5, the lower recess 78 may extend in an upwards direction from the substantially flat lower surface 76 of the top buffer and terminate at a substantially flat intermediate surface 84. In this case, the lower surface 76 of the top buffer 60 has an annular configuration with the lower recess 78 being arranged in the center. The intermediate surface 84 of the top buffer 60 may also have an annular configuration with the center being defined by the upper opening 70 in upper portion 64 of the buffer. Thus, the lower recess 78 and the upper opening 70 together may define a passage through the top buffer 60 that extends between the lower and upper surfaces 76, 68 thereof.

The lower recess 78 may be configured with first and second sections 86, 88 each of which has a respective interior wall 90, 92 that extends at a different angle (see, e.g., FIG. 5). In particular, the lower recess 78 may have a radiused edge 94 at the lower surface 76 of the top buffer 60 that extends into the first section 86 of the recess 78. The first section 86 may extend in the upward direction from the radiused edge 94 a predetermined distance into the lower recess 78. The second section 88 may begin at the termination of the first section 86 and extend from the end of the first section 86 to the intermediate surface 84 of the top buffer 60. Each of the first and second sections 86, 88 may have a truncated conical configuration with the respective interior wall 90, 92 extending at a different angle, with the angle D of the interior wall 90 of the first section 86 relative to a line parallel to the lower surface 76 being relatively greater than the angle E of the interior wall 92 of the second section 88 with respect to a line parallel to the lower surface.

When deformed under load, the differently angled interior walls 90, 92 of the first and second sections 86, 88 of the lower recess 78 can provide continuous contact with the side 96 of the protruding portion 82 of the accumulator assembly 42 as shown, for example, in FIG. 6. Such continuous contact can lead to lower stresses on the top buffer 60 and increase the life of the buffer. The outward bulging of the sidewall 74 of the top buffer 60 that is discussed above can also help the interior walls 90, 92 of the first and second sections 86, 88 of the lower recess 78 maintain continuous contact with the side 96 of the accumulator assembly 42 when the top buffer 60 is deformed under load. The continuous contact of interior walls 90, 92 of the recess with the side 96 of the accumulator assembly 42 also allows the top buffer 60 to absorb potential shear loads produced by the power cell 40 as well as to be self-aligning on the accumulator assembly 42.

According to one embodiment the interior wall 90 of the first section 86 of the recess may extend at an angle D of approximately 115° to approximately 120° relative to a horizontal line that is parallel to the lower surface 76 of the top buffer (see FIG. 5). Moreover, according to one embodiment, the interior wall 92 of the second section 88 may extend at an angle E of approximately 105° to approximately 110° relative to a horizontal line that extends parallel to the intermediate surface 84.

The interior walls of the first and second sections 86, 88 of the lower recess 78 may be configured such that they extend continuously in a radially inward direction (relative to the buffer body). In particular, as shown in FIG. 5, the interior wall 90 of the first section 86 may angle continuously in a radially inward direction starting from the lower surface 76 of the top buffer 60 to the location where the second section 88 begins in an unbroken manner and without any indented portions where the wall extends in a radially outward direction. Similarly, the interior wall 92 of the second section 88 also may angle continuously in a radially inward direction starting from where the first section 86 ends to where the second section 88 terminates at the intermediate surface 84 in an unbroken manner and without any radially outwardly indented portions. Such indented portions can be a source of crack initiation and propagation that may compromise the integrity of the buffer and decrease the life of the buffer.

### INDUSTRIAL APPLICABILITY

The hammer of the present disclosure is applicable for use with any type of machine or may be handheld. The buffer of the present disclosure, in turn, is applicable for use with any size hammer. The buffer may also be used in new hammer or retrofit into existing hammers. The buffer includes several features each of which can increase the life of the buffer and thereby reduce the downtime and the operating costs of the hammers with which it is used. The lower recess with two sections having differently angled interior walls can help ensure tight and continuous contact between the buffer and the sides of the accumulator assembly on which it is arranged. Such continuous contact may be further facilitated by an outward bulging of the sidewall of the body of the buffer. The lower recess may also allow the buffer to be substantially self-aligning on the accumulator assembly. This along with a single piece construction may make installation of the buffer easier. The elimination of any openings in the sidewall of the body of the buffer as well as any indentations in the interior walls of the first and second sections of the lower recess also may increase the life of the buffer as compared to known buffers having such features by eliminating sources of crack initiation and propagation.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A buffer for an upper surface of a power cell of a hammer, the buffer comprising:
a substantially cylindrical body having an upper surface, a lower surface and a sidewall; and
a recess extending into the body from the lower surface of the body for engagement with the upper surface of the power cell, the recess having a first section having a first interior wall extending inward relative to the body at a first angle with respect to a line parallel to the lower surface and a second section having a second interior wall extending inward relative to the body at a second angle with respect to the line parallel to the lower surface, wherein the first angle is greater than the second angle.

2. The buffer of claim 1 wherein an upper opening extends downward from the upper surface of the body, the upper opening having a substantially hourglass cross-sectional shape.

3. The buffer of claim 1 wherein the sidewall bulges outwardly with the bulge reaching its maximum at approximately a midpoint of the sidewall.

4. The buffer of claim 3 wherein the sidewall comprises a first surface that angles outward as the first surface extends away from the lower surface of the body and a second surface that angles outward as the second surface extends away from the upper surface of the body, the first and second surfaces intersecting at approximately the midpoint of the sidewall.

5. The buffer of claim 4 wherein the first and second surfaces each form an angle of approximately 2° to approximately 5° relative to a line extending perpendicular to the lower surface of the body.

6. The buffer of claim 1 wherein the body has a single piece construction.

7. The buffer of claim 1 wherein the body has a diameter and a height and wherein the diameter to height ratio is approximately 2.0 to approximately 2.4.

8. The buffer of claim 1 wherein the sidewall of the body is substantially solid with no openings formed therein.

9. The buffer of claim 1 wherein the first interior wall angles inward continuously until the first interior wall terminates at the second interior wall and the second interior wall angles inward continuously until the second interior wall terminates at an intermediate surface that extends parallel to the lower surface.

10. The buffer of claim 1 wherein the first angle is approximately 115° to approximately 120° relative to the lower surface and wherein the second angle is approximately 105° to approximately 110° relative to a line extending parallel to the lower surface.

11. A hammer comprising:
a housing;
a power cell arranged in the housing;
a buffer arranged on the power cell, the buffer including a substantially cylindrical body having an upper surface, a lower surface and a sidewall, a recess extending into the body from the lower surface of the body for engagement with an upper surface of the power cell, the recess having a first section having a first interior wall extending inward relative to the body at a first angle with respect to a line parallel to the lower surface and a second section having a second interior wall extending inward relative to the body at a second angle with respect to the line parallel to the lower surface, wherein the first angle is greater than the second angle.

12. The hammer of claim 11 wherein the sidewall comprises a first surface that angles outward as the first surface extends away from the lower surface of the body and a second surface that angles outward as the second surface extends away from the upper surface of the body, the first and second surfaces intersecting at approximately the midpoint of the sidewall.

13. The hammer of claim 12 wherein the first and second surfaces each form an angle of approximately 2° to approximately 5° relative to a line extending perpendicular to the lower surface of the body.

14. The hammer of claim 11 wherein the body has a single piece construction.

15. The hammer of claim 11 wherein the body has a diameter and a height and wherein the diameter to height ratio is approximately 2.0 to approximately 2.4.

16. The hammer of claim 11 wherein the sidewall of the body is substantially solid with no openings formed therein.

17. The hammer of claim 11 wherein the first interior wall angles inward continuously until the first interior wall terminates at the second interior wall and the second interior wall angles inward continuously until the second interior wall terminates at an intermediate surface that extends parallel to the lower surface.

18. The hammer of claim 11 wherein the first angle is approximately 115° to approximately 120° relative to the lower surface and wherein the second angle is approximately 105° to approximately 110° relative to a line extending parallel to the lower surface.

19. A buffer for an upper surface of a power cell of a hammer, the buffer comprising:
a substantially cylindrical single-piece body having an upper surface, a lower surface and a sidewall; and
a recess extending into the body from the lower surface of the body for engagement with the upper surface of the power cell, the recess having a first section having a first interior wall extending inward relative to the body at a first angle with respect to a line parallel to the lower surface and a second section having a second interior wall extending inward relative to the body at a second angle with respect to the line parallel to the lower surface;
wherein the first interior wall angles inward continuously until the first interior wall terminates at the second interior wall and the second interior wall angles inward continuously until the second interior wall terminates at an intermediate surface that extends parallel to the lower surface.

20. The buffer of claim 19 wherein the sidewall bulges outwardly with the bulge reaching its maximum at approximately a midpoint of the sidewall.
